(19) United States
(12) Patent Application Publication
(10) Pub. No.: US 2018/0229254 A1
(43) Pub. Date: Aug. 16, 2018

(54) ROAD MARKING DEVICE AND METHOD

(71) Applicant: Gary L. Vandergriff, Midland, TX (US)

(72) Inventor: Gary L. Vandergriff, Midland, TX (US)

(21) Appl. No.: 15/891,674

(22) Filed: Feb. 8, 2018

Related U.S. Application Data
(60) Provisional application No. 62/456,717, filed on Feb. 9, 2017.

(51) Int. Cl. B05B 12/00; B05B 7/24

(52) U.S. Cl. CPC B05B 12/002; B05B 7/2489

(57) ABSTRACT

A method for marking the ground adjacent to a motor vehicle includes the steps of observing an event exterior to the motor vehicle, remotely activating a ground marking device connected with the motor vehicle, and marking the ground exterior to and below the motor vehicle with the ground marking device. Remotely activating the ground marking device can include engaging an electronic switch while a person is within the motor vehicle.

The present application claims the benefit of U.S. provisional application No. 62/456,717, filed Feb. 9, 2017, the entire contents of which is hereby incorporated by reference.

### BACKGROUND OF THE INVENTION

The present invention relates to road marking methods. More particularly it relates to a method for marking a road with a road marking device that is attached to a motor vehicle. The method makes it easier and more convenient to mark an area of the road without requiring that a person leave the motor vehicle.

In the line of duty, law enforcement officers and those in similar positions at times find themselves in pursuit of a person or persons in a motor vehicle. While in pursuit, there may be an event that draws the attention of the officer, for instance someone in the motor vehicle being pursued may throw potential criminal evidence out of a window. The officer may want to note the location of the event, but because the officer is in pursuit of the motor vehicle, doing so is difficult. He or she cannot stop the motor vehicle at that moment to either make a note or investigate the potential criminal evidence.

When those types of situations arise, an officer typically has to rely on his or her memory of landmarks or other indicia in the general area in the hopes of remembering enough about the area so that he or she can return for future investigation or to detail the location in a report. This puts a heavy, unnecessary burden on the officer. Alternatively, if the officer is driving with a partner or has access to someone else at a remote location, for instance a police station, the officer could dictate what he or she saw for the other person to note. In either instance, officers are burdened with having to recall the location of the event through flawed techniques.

Law enforcement officers and others in similar positions are in need of a better way of noting the location of an event such as that described above. This will assist them in their reporting of the event and in conducting further investigation of the location once the pursuit has ended.

### SUMMARY OF THE INVENTION

Accordingly, it is an object of the present disclosure to provide a method for marking the ground adjacent to a motor vehicle. The steps for doing so include observing an event exterior to the motor vehicle, remotely activating a ground marking device connected with the motor vehicle, and marking the ground exterior to and below the motor vehicle with the ground marking device in response to the event. Remotely activating the ground marking device preferably includes engaging an electronic switch while a person is within the motor vehicle. However, the remotely activating step can be completed by other techniques or devices, such a voice command, electronic sensor, or by other techniques known to those of skill in the art. In addition, the method could be practiced without a person in the motor vehicle, for instance as with a driverless motor vehicle.

In a separate method of the present disclosure, the marking the ground step includes the steps of sending an electronic signal to a bolt of the ground marking device, releasing a valve which controls a high-pressure gas system of the ground marking device, releasing a high-pressure gas of the gas system into a barrel of the ground marking device, and ejecting a ground marking component through the barrel of the ground marking device toward the ground below. Preferably, the ejecting step includes ejecting a dye-filled gelatin capsule that bursts upon impact with the ground.

In yet another method of the present disclosure, the observing step as disclosed above includes a law enforcement officer observing suspected criminal activity. The method can also include the step of returning to the area noted by the marking to investigate the suspected criminal evidence.

### BRIEF DESCRIPTION OF THE FIGURES

Other objects and advantages of the disclosure will become apparent from a study of the following specification when viewed in the light of the accompanying drawing, in which:

FIGS. 1 is a perspective view of a motor vehicle marking the ground exterior to the motor vehicle according to the method of the present disclosure;

FIG. 2 is a flow chart demonstrating one method of the present disclosure; and

FIGS. 3 is a flow chart demonstrating a second method of the present disclosure.

### DETAILED DESCRIPTION

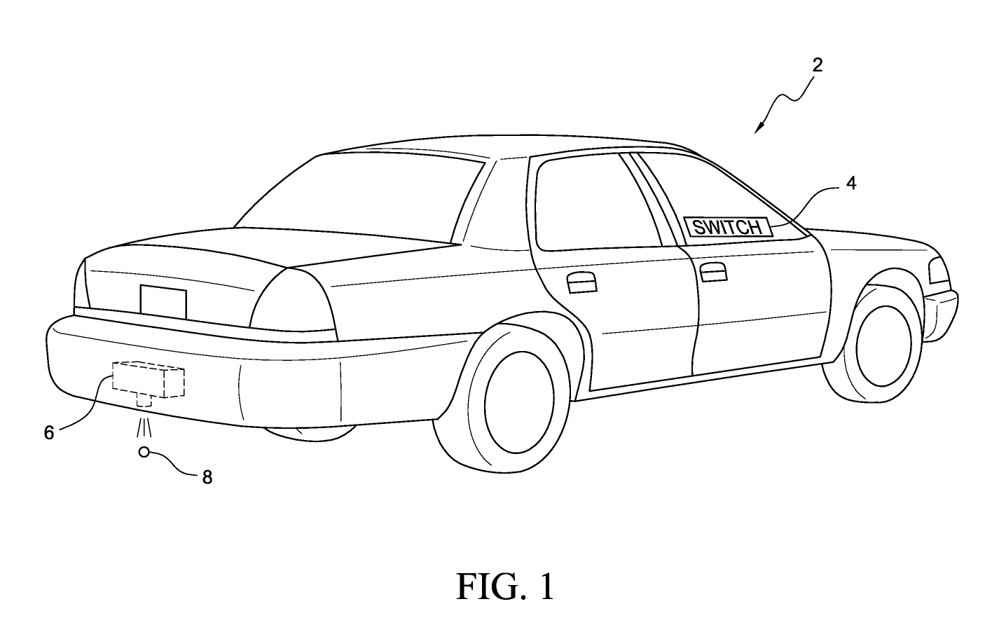

Referring first to FIG. 1, there is shown a motor vehicle 2 including a switch 4, a ground marking device 6, and a ground marking component 8. When a person is driving the automobile 2, or is otherwise in control of it and an event takes place near the automobile that the driver would like to note, he or she engages the switch 4 which activates the ground marking device 6 and ejects the ground marking component 8 toward the ground. The ground marking component, preferably a dye-filled gelatin capsule, bursts upon impact with the ground leaving a mark thereon. Therefore, the ground is marked without requiring the driver to leave the car to effectuate the marking. Subsequently, the driver can return to the location of the marked ground to more precisely locate the noted area.

In FIG. 1, the ground marking device 6 is located at the rear of the motor vehicle to eject the ground marking component 4 toward the ground near the rear end of the motor vehicle 2. It will be understood by those skilled in the art that the device could be connected with any part of the motor vehicle so long as the device is capable of marking the ground adjacent to the motor vehicle when activated.

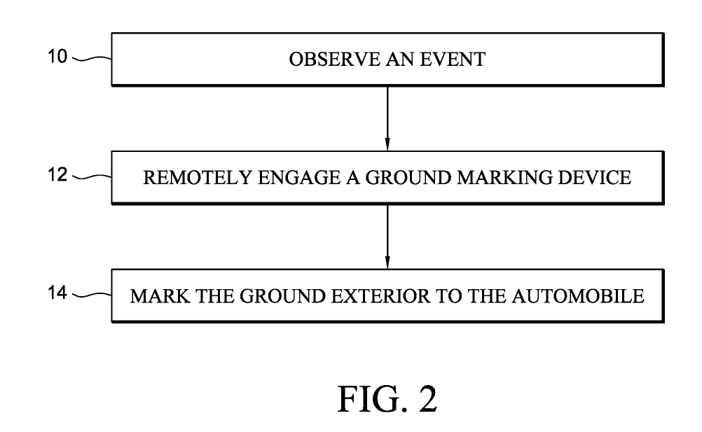

FIG. 2 details the steps of a method for marking the ground exterior to a motor vehicle. It includes observing an event 10 that is exterior to a motor vehicle 2, the location of which the driver of the motor vehicle would like to note. To note the location, the driver remotely engages 12 a ground marking device connected with the motor vehicle. Preferably, the ground marking device is engaged via a switch 4 connected to the device and located inside the motor vehicle. The switch is within reach of the motor vehicle driver's seat. It will be apparent to those skilled in the art that there may be other techniques for engaging the ground marking device, for instance by voice command or a switch that is not located in the motor vehicle but is at a remote location, such as a control center. Once engaged, the device releases a component 8 for marking the ground 14 exterior to and below the motor vehicle. That component could be of any type known in the ground marking industry, but preferably is a dye-filled gelatin capsule that bursts upon impact with the ground.

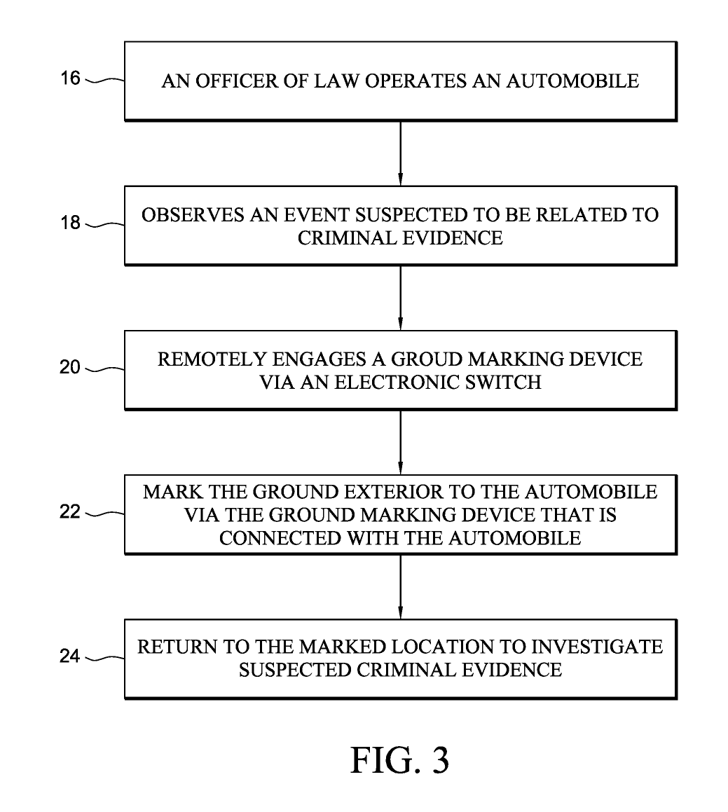

FIG. 3 discloses the steps of a further method according to the present disclosure. For this method, a law enforcement officer is operating a motor vehicle 16. If the officer observes an event 18 that he or she suspects to be related to criminal activity or criminal evidence, the officer remotely engages 20 a ground marking device which is attached to the motor vehicle to mark the ground 22 exterior to the motor vehicle to denote the location for future investigation. By marking the ground, when the officer returns 24, he or she can more easily locate the precise location where the criminal activity took place or where evidence can be found without having to rely on his or her memory. So long as the officer has a general idea of where he or she marked the ground, he or she will be able to find the precise location upon return. As with the method of FIG. 2, the ground marking component used to mark the ground in the method of FIG. 3 can be accomplished by using any type of component known in the field, but preferably is accomplished by ejecting a dye-filled gelatin capsule that bursts upon impact with the ground.

Preferably, the ground marking device of the disclosed methods is a paintball marker, such as those used in paint ball competitions or with forestry or cattle marking. The marker includes a housing with a solenoid valve, bolt and valve assembly, a barrel, a high-pressure gas system connected to the housing, and a container for holding ground marking components, also connected to the housing. It will be apparent to those skilled in the art that the presently disclosed methods of marking the ground do not require the ground marking device to be a paintball marker but could be any ground marker that is applicable to the present methods.

The following is an example of how the ground marking device described above operates. Those skilled in the art will understand that other devices could be used to accomplish the steps of the disclosed methods. First, an electronic signal is sent to the solenoid valve of the ground marking device 6 via the electronic switch 4. Once the signal is received, a spring-loaded bolt releases, in turn engaging and releasing the valve. The released valve allows high-pressure gas to flow freely into the housing. The gas then fills the barrel and ejects the ground marking device through the end of the barrel and toward the ground. Simultaneously, the gas flows to the bolt and valve assembly forcing the bolt back to its starting position and locking it in place, loading the spring, sealing the valve, and cutting off the gas from the housing. This process can be repeated when a subsequent event takes place and the ground marking device is again engaged.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised and employed without departing from the spirit and scope of the present invention as defined by the appended claims.

What is claimed is:

1. A method for marking the ground adjacent to a motor vehicle, comprising the steps of:
(a) observing an event exterior to the motor vehicle;
(b) remotely activating a ground marking device connected with the motor vehicle; and
(c) marking the ground adjacent to the motor vehicle with the ground marking device in response to the event.

2. A method as defined in claim 1, wherein said remotely activating step includes engaging an electronic switch.

3. A method as defined in claim 2, wherein said remotely activating step is completed from within the motor vehicle.

4. A method as defined in claim 1, wherein said marking the ground step comprises the steps of:
(a) sending an electronic signal to a bolt of the ground marking device;
(b) releasing a valve which controls a high-pressure gas system of the ground marking device;
(c) releasing a high-pressure gas system into a barrel of the ground marking device; and
(d) ejecting a ground marking component through the barrel of the ground marking device toward the ground adjacent to the motor vehicle.

5. A method as defined in claim 4, wherein said ejecting a ground marking component step includes ejecting a dye-filled gelatin capsule that bursts upon impact with the ground.

6. A method as defined in claim 1, and further comprising the step of operating the motor vehicle.

7. A method as defined in claim 1, wherein said observing an event step includes a law enforcement officer observing suspected criminal evidence or activity.

8. A method as defined in claim 7, and further comprising the step of returning to the area containing the marked ground to investigate the suspected criminal evidence or activity.
